(19) United States
(12) Patent Application Publication
(10) Pub. No.: US 2007/0254724 A1
(43) Pub. Date: Nov. 1, 2007

(54) Universal, Multi Mobile Device Holder

(76) Inventor: Owen Oliver Daniels, (US)

Correspondence Address: OWEN O. DANIELS, 7665 N. SHERIDAN RD., APT. 3A, COOK, IL, 60626, US

(21) Appl. No.: 11/381,114

(22) Filed: May 1, 2006

(51) Int. Cl. H04B 1/08; H04M 1/00

(52) U.S. Cl. 455/569.1; 455/575.1; 455/347

(57) ABSTRACT

A universal, multi-mobile device holder for securing multiple mobile devices in an automobile while they are being charged with a charging cable obtained by the users from the mobile device provider. The holder includes vertical and lateral control bars to secure the mobile devices and to obtain the best viewing of the instruments while in the holder. Retaining grommets at the bottom holds the charging end of the device charging cables in place so that it can connect to the mobile device at the opening at the base of holder. The other end of the charging devices is plugged into a dual port receptacle which in-turn is plugged into the automobile lighter receptacle.

### FIELD OF INVENTION

The present invention relates generally to a universal, multi-holder for portable communication devices.

### BACKGROUND OF THE INVENTION

Portable electronic devices such as cell phones has become as popular as the automobile. Almost everyone who owns a car also owns a phone. While driving, users are often compel to recharge their phones. Quite often individuals posess two phones (one for business, and one for personal use). More and more users are switching to phones with wireless headsets which also has to be recharged (in addition to the phone itself) when the battery dies. More and more individuals are sharing rides, whether it be commuting back and forth to work, taking business trips, or families going on vacation. As a result of these new dynamics, the need to recharge multiple mobile devices while in commute has arisen. New cell phones with modern designs are being sold every day. These new designs don't confirm to earlier invention of phone mounts. Earlier invention of phone mounts only permit one phone to be held and charge at a time. Hence the need for a Universal Multi-Mobile Portable Device Holder. A holder that can accommodate more than one mobile device at the same time or mobile devices whose design change over time (for example with the charging port relocated to different places on the phone).

### DESCRIPTION OF THE PRIOR ART

U.S. Pat. No. 6,341,218 issued to Ralph C. Poplawsky, Kathryn D. Delianides and James T. Wilkinson, on 22 Jan. 2002 describes an adapter for supporting and connecting a portable electronic device.

U.S. Pat. No. 6,816,713 issued to Tonny Chen on 9 Nov. 2004 describes a switching and retaining device for use in cellular phones and peripheral communication equipment.

U.S. Pat. No. 6,095,470 issued to Robert M. Kalis on 1 Aug. 2000 describes a mounting device for removably attaching a hand-held electronic instrument to a support surface.

U.S. Pat. No. 6,362,791 issued to Gregory Scott Patterson on 26 Mar. 2002 describes a portable communication device holder and antenna.

U.S. Pat. No. 5,187,744 issued to Gary L. Richter on 16 Feb. 1993 describes a hand-held portable telephone holder for releasably holding a hand-held portable car telephone.

U.S. Pat. No. 5,480,115 issued to Gary P. Hartlof on 2 Jan. 1996 describes a bracket holding an instrument in a latched position.

U.S. Pat. No. 5,179,590 issued to Fore S. Wang on 12 Jan. 1993 described a mobile telephone rack assembly comprising a telephone rack holding a mobile telephone.

U.S. Pat. No. 5,535,274 issued to Michael F. Braitberg, Patrick J. Kennedy, Lester B. Hatcher, Davide Andrea and Gregory D. Volan on 9 Jul. 1996 described a universal connection for cellular telephone interface.

None of the above noted patents, taken either singularly or in combination, are seen to disclose the specific arrangement of concepts disclosed by the present invention.

### SUMMARY OF THE INVENTION

The current invention provides for a more cost efficient and effective holding system in an automobile. This system can be placed at any location in the automobile suitable to the individual. It can be semi permanently attached (using Velcro) or permanently designed into the dashboard or other areas of the automobile by automobile manufacturers. It permits owners of mobile devices to utilize the charging cables designed for their respective devices while utilizing a “multiple car lighter receptacle” for charging multiple devices at the same time. The holder can be adjusted by moving the adjustable dividers to respective positions to accommodate multiple or unusual size devices.

### BRIEF DESCRIPTION OF THE DRAWINGS

FIG. 1 is a frontal view of the present invention

FIG. 2 is a frontal view of the present invention depicting how the dividers can be adjusted to accommodate different size devices.

FIG. 3 is a rear view of the present invention depicting how the holder can be secured with Velcro.

FIG. 4 is a front view depicting the use of mobile device charging cables with “multiple car lighter receptacle”.

### DETAILED DESCRIPTION OF THE PREFERRED EMBODIMENT

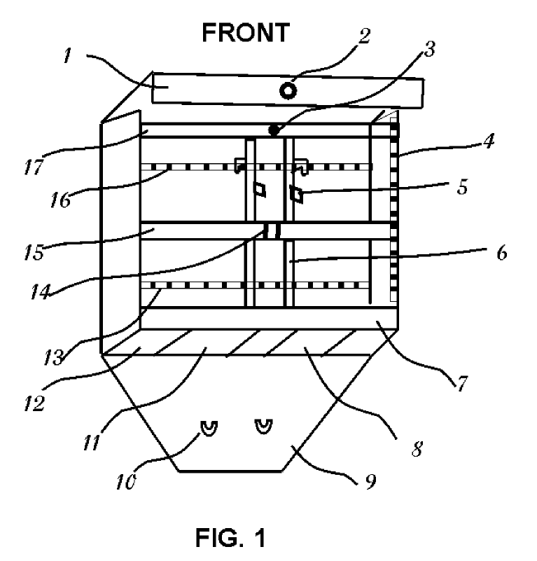

Referring to the drawings ranging from FIG. 1 to FIG. 4, the present invention relating to a holding device for use in automobiles is made of a single piece which can be mounted in a convenient location (such as a dashboard for front seat passengers or the back of one of the front seats for passengers in the rear).

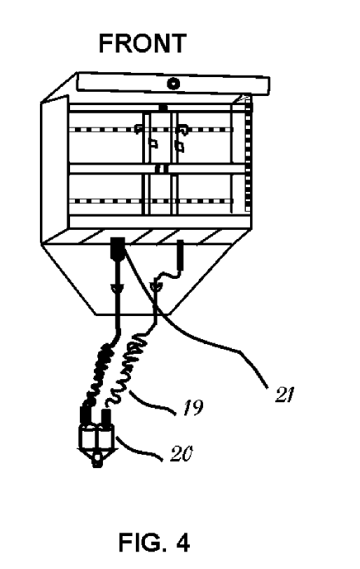

The holder is made up of a cover 1 with a securing lock 2 & 3 that secures the mobile device in the holder and prevents it from being ejected. A horizontal bar 15 can be adjusted vertically utilizing the adjuster levers 14 to allow for the best viewing of the devices while preventing the devices from being ejected while they are in the holder. The notched grooves 4 located on the sides of the holder allows for vertical movements of the horizontal bar 15. Two vertical bars 6 can be adjusted horizontally to secure the devices in place. The notched grooves 13 & 16 located in the rear of the holder allows for horizontal adjustments of the dividers. Openings 8 & 11 in the base allows for the connection of mobile device chargers to connect to the mobile devices. The retaining circular grommets 10 located at the base 10 of the holder secures the head of the mobile device charging cable FIG. 4, 20 which is then plugged into a multi port lighter receptacle 19 which in-turn is then be plugged into the automobile's lighter receptacle.

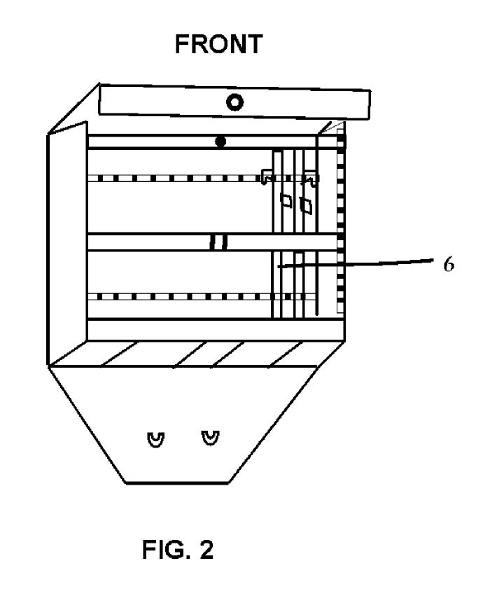

FIG. 2 depicts how the vertical bars 6 can be adjusted for a larger device or for a device with the charging port on its side that has to be turned sideways in order to meet the charger at the base.

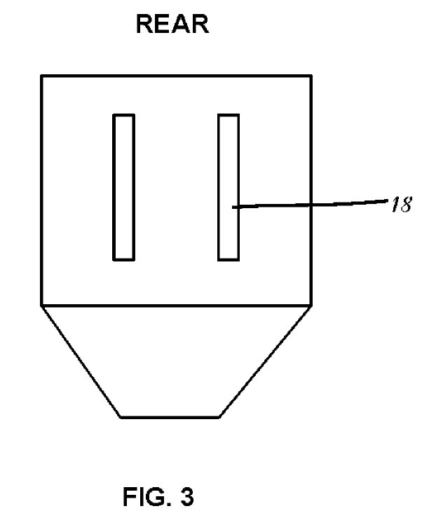

FIG. 3 depicts the rear of the holder with Velcro straps attached that can be utilized to secure the holder to a surface.

What is claimed is:

1. A holder for holding of multiple mobile devices, comprising:
a holding area divided into sections than can accommodate more than one device at a time,
a holding device that can be semi-permanently attached to any surface in an automobile via Velcro, a holding device that can be permanently designed into the dashboard or back of a seat of an automobile, or other surfaces of the automobile thereof.

2. The apparatus for holding multiple mobile devices according to claim 1, wherein said device has an horizontal bar that can be adjusted vertically.

3. The apparatus for holding multiple mobile devices according to claim 1, wherein said device has a cover with a securing lock to prevent the mobile device from ejecting.

4. The apparatus for holding multiple mobile devices according to claim 1, wherein said device has retaining grommets to secure the charging heads of mobile device chargers.

5. The apparatus for holding multiple mobile devices according to claim 1, wherein said device has openings in the base of the holder to accommodate varying size charging ports from mobile device chargers.
